(19) United States
(12) Patent Application Publication
(10) Pub. No.: US 2024/0361713 A1
(43) Pub. Date: Oct. 31, 2024

(54) FIXING DEVICE AND IMAGE FORMING DEVICE

(71) Applicant: Sharp Kabushiki Kaisha, Osaka (JP)

(72) Inventors: Minoru TOMIYORI, Osaka (JP); KIMIHIDE TSUKAMOTO, Osaka (JP); Yosuke ASANO, Osaka (JP)

(21) Appl. No.: 18/646,609

(22) Filed: Apr. 25, 2024

(30) Foreign Application Priority Data
Apr. 25, 2023 (JP) 2023-071722

(51) Int. Cl. G03G 15/20

(52) U.S. Cl. CPC G03G 15/2028; G03G 15/2064

(57) ABSTRACT

A paper guide is disposed at an introduction unit of a fixing device of an image forming device. The paper guide is disposed over a width direction of a transfer path through which a sheet is guided to the introduction unit. One end portion and another end portion, in the width direction, of the transfer path of the paper guide have a step-down surface that retracts from the sheet.

### CROSS-REFERENCE TO RELATED APPLICATION

The present application claims priority from Japanese Application JP2023-071722, the content of which is hereby incorporated by reference into this application.

### BACKGROUND OF THE INVENTION

### 1. Field of the Invention

The present disclosure relates to a fixing device and an image forming device.

### 2. Description of the Related Art

Typically, an image forming device is configured such that a toner image is transferred to a sheet by an image transferring unit, and then, is fixed through heating and pressing by a fixing device to form an image on the sheet.

For example, in a case where such an image forming device is used to perform full bleed (no margins) printing on an A4R sheet, this sheet passes through in a manner such that the sheet covers only a middle portion, in the width direction, of a transfer path of a band plate-shaped paper guide provided at an introduction unit of the fixing device, and one end portion and another end portion, in the width direction, of the transfer path of the paper guide are exposed. Thus, during a process in which the sheet on which a toner image has been transferred by the image transferring unit is introduced into the introduction unit of the fixing device, there may occur a case in which the toner transferred at or around the sheet end portions flies off, and this toner is attached and accumulated at the one end portion and the other end portion, in the width direction, of the transfer path of the paper guide.

Thus, in a case where normal printing is performed for an A3 sheet or A4 sheet after the previous printing described above, this sheet passes through the paper guide so as to cover the entire region in the width direction of the transfer path of the paper guide. This may lead to spreading of the toner accumulated at the one end portion and the other end portion in the width direction of the transfer path of the paper guide, thereby contaminating this sheet.

In a situation in which such printing is performed, there is known an example that suppresses or prevents spreading of the toner to a sheet used in the subsequent printing, in which “In an image forming device, toner that has not been transferred is deliberately attached on a rear surface of the next sheet that is caused to pass through, and the number of sheets for this falls in a range that does not cause any trouble, whereby the toner is not accumulated on the conveying guide member,” for example.

In addition, there is known another example in which “In an image forming device, an image formation region having a size greater than a recording sheet is provided in order to achieve non-margin recording, and excessive toner attached on the edge of the recording sheet is cleaned using a cleaning member, thereby suppressing contamination at the edge”.

Furthermore, there is known another example in which “In an image forming device, the degree of necessity of removing toner attached at both end portions of a recording sheet is taken into consideration, and the toner is appropriately removed”.

### SUMMARY OF THE INVENTION

The person of the present disclosure reaches an idea aimed at suppressing or preventing spreading of toner to a sheet used in the subsequent printing in a situation in which such printing described above is performed. This idea includes preparing, in advance, a plurality of paper guides having different sizes in the width direction of the transfer path, and making replacement to attach a paper guide having a size that fits each printing manner.

However, in this case, a plurality of paper guides having different sizes need to be prepared, and time and efforts are required to replace the paper guides. Thus, there is room for improvement.

In view of the circumstances as described above, an object of the present disclosure is to provide a fixing device and an image forming device. In a situation in which printing is performed in a manner such that a recording medium such as a sheet passes through a paper guide so as to cover only a middle portion, in the width direction, of a transfer path of the paper guide, and then, printing is performed in a manner such that the sheet passes through the paper guide so as to cover the entire region, in the width direction, of the transfer path of the paper guide, the fixing device and the image forming device suppress or prevent spreading of toner to the sheet in the fixing process of the subsequent printing without using a plurality of paper guides having different sizes in the width direction of the transfer path.

A first aspect of the present disclosure provides a fixing device including: an introduction unit through which a recording medium having a front surface on which a toner image is transferred is introduced; and a fixing member that applies heat and pressure to the introduced recording medium to fix the toner image on the recording medium, in which a paper guide that guides the recording medium to the fixing member is disposed at the introduction unit, the paper guide is disposed over a width direction of a transfer path through which the recording medium is guided to the introduction unit, and one end portion and another end portion, in the width direction, of the transfer path of the paper guide have a step-down surface that retracts so as not to come into contact with the recording medium.

Incidentally, it is preferable that one or more projection portions be provided at the step-down surface, the projection portion coming into contact with the recording medium to cause the recording medium to be spaced apart from the step-down surface.

In addition, it is preferable that the projection portion have a rib-shaped body extending at the paper guide from upstream to downstream in a transport direction of the recording medium, and the projection portion have a diagonal posture to change a contact position with the recording medium from a middle position in the transport direction toward one end side and another end side, in the width direction, of the transfer path of the paper guide.

In addition, it is preferable that a plurality of the projection portions be provided on each of the step-down surfaces so as to be adjacent to and parallel to each other.

In addition, it is preferable that the projection portion be formed such that the amount of protrusion from the step-down surface decreases upstream and increases downstream in the transport direction.

In addition, it is preferable that the paper guide is formed of an electrically conductive member, and the projection portion is formed separately from the paper guide and is formed of an electrically conductive member differing from the paper guide.

Furthermore, an image forming device including the fixing device according to the solving means described above is also within the scope of technique of the present disclosure.

With the fixing device and the image forming device according to the aspects of the present disclosure, in a situation in which printing is performed in a manner such that a sheet passes through a paper guide so as to cover only a middle portion, in the width direction, of the transfer path of the paper guide, and then, printing is performed in a manner such that the sheet passes through the paper guide so as to cover the entire region, in the width direction, of the transfer path of the paper guide, it is possible to suppress or prevent spreading of toner to the sheet in the fixing process of the subsequent printing without using a plurality of paper guides having different sizes in the width direction of the transfer path.

### BRIEF DESCRIPTION OF THE DRAWINGS

FIG. 1 is a schematic explanatory diagram of an image forming device according to a first embodiment of the present disclosure.

FIG. 2 is a perspective view of a fixing device.

FIG. 3 is a perspective view of a paper guide.

FIG. 4 is a perspective view of a back surface of the paper guide.

FIG. 5 is a front view of the paper guide.

FIG. 6 is a rear view of the paper guide.

FIG. 7 is a side view of the paper guide in FIG. 5 when viewed from the right side.

FIG. 8 is a plan view of the paper guide.

### DETAILED DESCRIPTION OF THE INVENTION

A fixing device and an image forming device according to embodiments of the present disclosure will be described with reference to the drawings.

### (Entire Configuration of Image Forming Device)

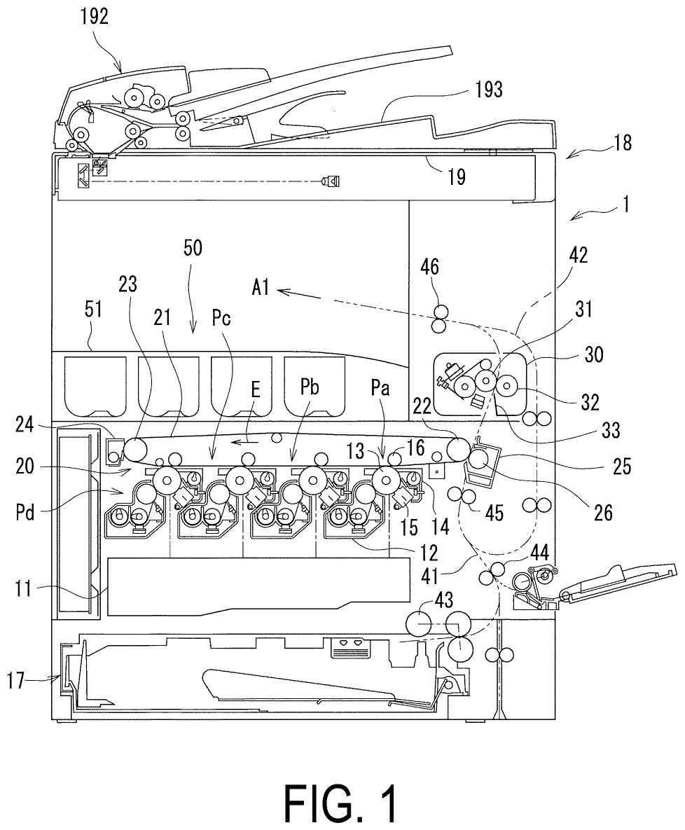

FIG. 1 is a schematic explanatory diagram illustrating an image forming device 1 according to a first embodiment of the present disclosure.

The image forming device 1 is a multifunction device having a scanner function, a copy function, a printer function, a facsimile function, and the like, and includes an optical scanning device 11, a sheet feeding device 17, an image scanning device 18, an image transferring unit 20, an intermediate transfer belt 21, a fixing device 30, a sheet conveying path 41, an output tray device 50, and the like.

This image forming device 1 transmits, to the outside, an image of a document scanned by the image scanning device 18, and also forms an image of the scanned document or an image received from the outside on a sheet serving as a recording medium in color or in a single color.

The image forming device 1 deals with image data corresponding to a color image made of individual colors of black (K), cyan (C), magenta (M), and yellow (Y), or a monochrome image made of a single color (for example, black).

The image scanning device 18 scans a document on a document table 19 or a document conveyed from a document conveying unit (ADF) 192 to generate image data. The scanned document is discharged to a document discharge tray 193.

The image transferring unit 20 includes four development devices 12, four photoreceptor drums 13, four drum cleaning devices 14, and four chargers 15 used to form four types of toner images, whereby four image stations Pa, Pb, Pc, and Pd are formed so as to correspond to black, cyan, magenta, and yellow, respectively.

The optical scanning device 11 exposes the front surface of the photoreceptor drum 13 to form an electrostatic latent image. The development device 12 develops an electrostatic latent image on the front surface of the photoreceptor drum 13 to form a toner image on the front surface of the photoreceptor drum 13. A toner image made of a corresponding color is formed on the front surface of each of the photoreceptor drums 13. The drum cleaning device 14 removes and collects the residual toner on the front surface of the photoreceptor drum 13. The charger 15 causes the front surface of the photoreceptor drum 13 to be uniformly electrically charged at a predetermined electric potential.

An intermediate transfer roller 16 is disposed at an upper side of the photoreceptor drum 13 with the intermediate transfer belt 21 being interposed between them. The intermediate transfer belt 21 serves as an image carrier on which a toner image is formed. The intermediate transfer belt 21 is looped over a transfer driving roller 22 and a transfer driven roller 23, and rotates (circular movement) in a direction of the arrow E. The toner images made of corresponding colors formed on the front surfaces of the individual photoreceptor drums 13 are transferred (primary transfer) and are superimposed to form a color toner image on the front surface of the intermediate transfer belt 21.

A transfer roller 26 of a second transferring unit 25 constitutes a nip region (secondary transfer position) between itself and the intermediate transfer belt 21, and sandwiches the sheet conveyed through the sheet conveying path 41 to convey it. When the sheet passes through the nip region, a toner image on the front surface of the intermediate transfer belt 21 is transferred to the sheet, and the sheet is conveyed to the fixing device 30. The toner or the like left on the intermediate transfer belt 21 is collected by a belt cleaning device 24.

The sheet feeding device 17 accommodates sheets used in image formation, and is provided at the lower side of the optical scanning device 11. The sheet is pulled out from the sheet feeding device 17 by a pickup roller 43, and is conveyed through the sheet conveying path 41. Then, the sheet passes through the second transferring unit 25 and the fixing device 30, and is conveyed through the sheet discharge roller 46 to an output tray 51 of the output tray device 50. Various types of roller pairs are disposed on the sheet conveying path 41, which include a registration roller 45 that temporarily stops the sheet to align the leading edge of the sheet and then, starts conveying the sheet at the timing at which a color toner image is transferred in the nip region between the intermediate transfer belt 21 and the transfer roller 26. The various types of roller pairs also include a plurality of conveying rollers 44 that facilitate conveying the sheet, a sheet discharge roller 46, and the like.

The fixing device 30 includes at least a fixing roller 31, a pressure roller 32, and a paper guide 33. The fixing device 30 sandwiches, between the fixing roller 31 and the pressure roller 32, the sheet on which the toner image has been transferred, and applies heat and pressure to fix the toner image on the sheet.

The pickup roller 43 is provided in the vicinity of the end portion of the sheet feeding device 17, and is a drawing roller that supplies accommodated sheets to the sheet conveying path 41 one by one. The registration roller 45 temporarily holds a sheet conveyed from the sheet feeding device 17, and conveys the sheet to the transfer roller 26 at the timing that matches when the leading end of the toner image on the photoreceptor drum 13 and the leading end of the sheet align with each other.

In a case where an image is formed not only on the front surface of the sheet but also on the rear surface, the sheet is conveyed in the reverse direction from the sheet discharge roller 46 to a sheet inversion conveying path 42 to invert the front surface and the rear surface of the sheet. Then, the sheet is guided to the registration roller 45 again to form an image on the rear surface in a manner similar to the front surface. After this, the sheet is conveyed to the output tray 51 of the output tray device 50. The sheet discharge roller 46 is driven so as to discharge the sheet in a discharge direction (direction of the arrow Al) that is a sub-scanning direction.

The output tray device 50 includes the output tray 51 that receives a sheet having passed through the sheet conveying path 41 and discharged by the sheet discharge roller 46.

The output tray 51 is provided so as to be elongated in a direction in which the sheet is discharged. The tray upper surface serving as the upper surface of the output tray 51 includes a region that has a substantially horizontal surface and is disposed downstream in the direction in which the sheet is discharged. A region having an inclined surface is provided at the upstream side of the tray upper surface that is a substantially horizontal surface, so as to be continuously connected. With this configuration, a space is provided below the sheet discharge roller 46, which allows a plurality of sheets to be loaded on the output tray 51.

### First Embodiment

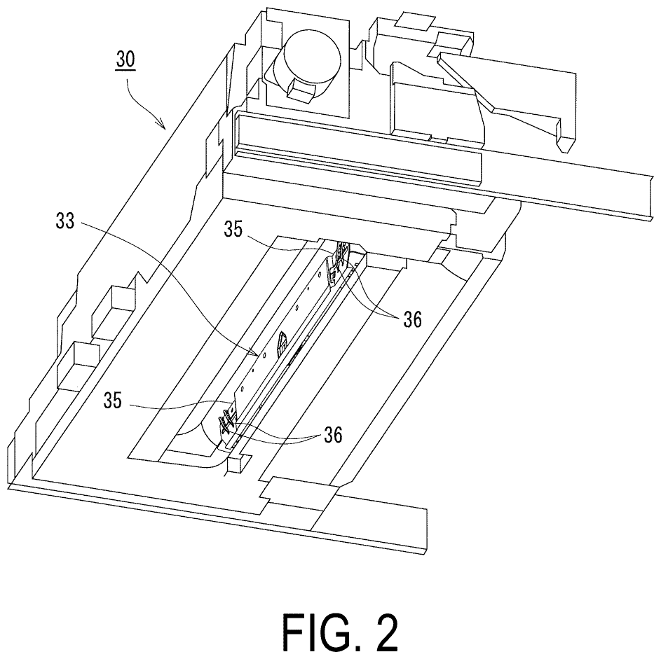

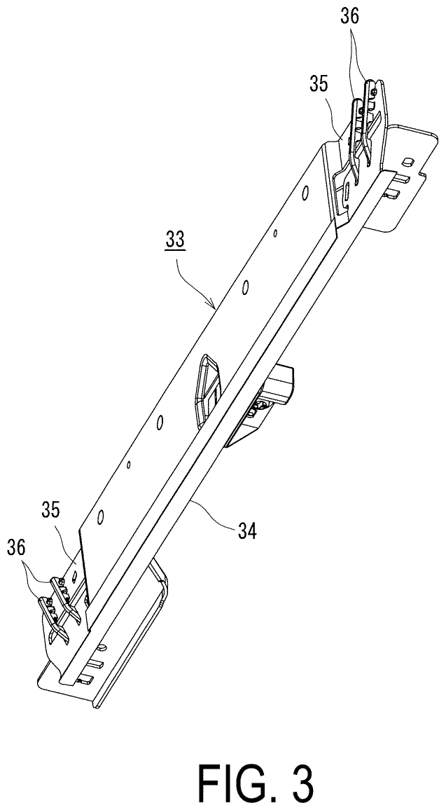

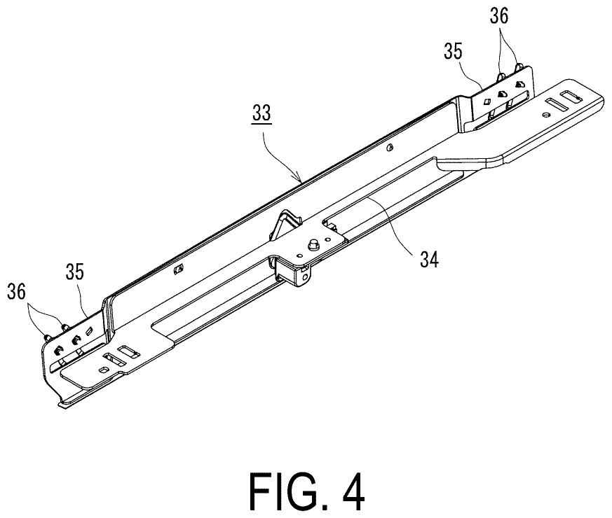

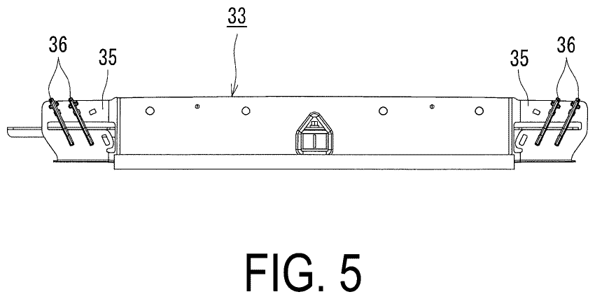

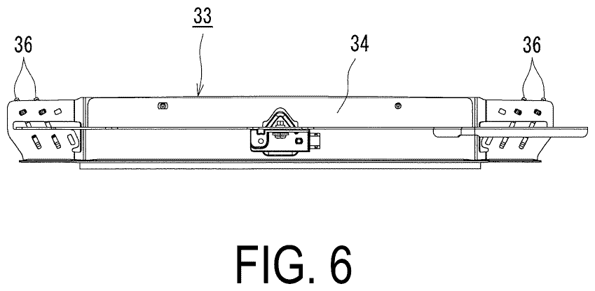

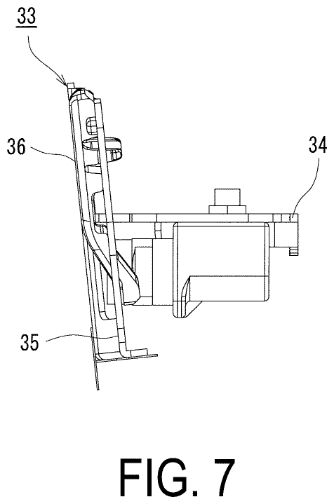

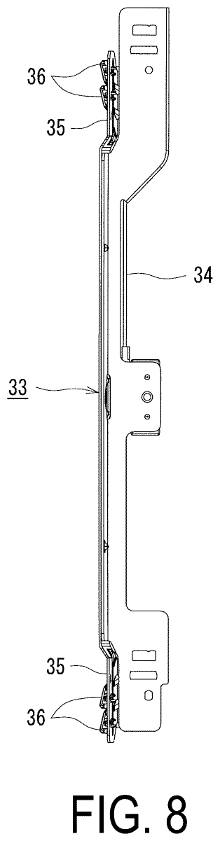

FIG. 2 is a perspective view of the fixing device 30. FIG. 3 is a perspective view of the paper guide 33. FIG. 4 is a perspective view of the back surface of the paper guide 33. FIG. 5 is a front view of the paper guide 33. FIG. 6 is a rear view of the paper guide 33. FIG. 7 is a side view of the paper guide 33 in FIG. 5 when viewed from the right side. FIG. 8 is a plan view of the paper guide 33.

The fixing roller 31 and the pressure roller 32 of the fixing device 30 constitute a fixing member that sandwiches a sheet (recording medium) on which a toner image has been transferred on the front surface, to apply heat and pressure to it and rotate.

The paper guide 33 of the fixing device 30 is disposed at an introduction unit used to introduce, into the fixing device 30, the sheet having passed through the second transferring unit 25, and guides the sheet having passed through the second transferring unit 25 toward the nip region between the fixing roller 31 and the pressure roller 32.

As illustrated in FIG. 5, the paper guide 33 is formed in a substantially band-plate shape in front view, and is disposed over the width direction of a transfer path through which the sheet is guided to the introduction unit. In the first embodiment, the size of the entire length, in the width direction, of the transfer path of the paper guide 33 is set, for example, so as to be equal to or slightly smaller than the long side of an A4 sheet or the short side of an A3 sheet.

The paper guide 33 is attached to a frame (not illustrated) of the fixing device 30 through a bracket 34.

The bracket 34 is attached to the rear surface of the paper guide 33 as illustrated in FIGS. 4 and 8.

An attachment piece (to which no reference character is attached) is provided at a middle portion, one end portion, and another end portion, in the width direction, of the transfer path of the bracket 34. This attachment piece includes a hole (to which no reference character is attached) through which a bolt (not illustrated) is inserted, the bolt being used to attach the bracket 34 to the frame of the fixing device 30.

A step-down surface 35 is provided at one end portion and another end portion, in the width direction, of the transfer path of the paper guide 33.

The step-down surface 35 retracts from the middle portion, in the width direction, of the transfer path of the paper guide 33. Here, the “retract” means a direction away from the transfer path for a sheet, in other words, a direction toward a side that is separated from the sheet to be conveyed and not in contact with the sheet. With this configuration, the sheet introduced into the introduction unit of the fixing device 30 slides on and comes into contact with the middle portion of the paper guide 33 while not coming into contact with the step-down surface 35.

A projection portion 36 is provided at the step-down surface 35. The projection portion 36 is provided so as to protrude from the step-down surface 35 toward the middle portion, in the width direction, of the transfer path of the paper guide 33. In addition, the projection portion 36 causes the sheet to be spaced apart from the step-down surface 35 while coming into contact with the sheet to guide the sheet toward the nip region between the fixing roller 31 and the pressure roller 32.

The projection portion 36 includes a rib-shaped body that extends at the paper guide 33 from upstream to downstream in a transport direction of the sheet. In the first embodiment, the projection portion 36 is formed separately from the paper guide 33.

As illustrated in FIG. 5, the projection portion 36 is attached to the step-down surface 35 so as to have a diagonal posture of which contact position changes from the middle position in the transport direction toward one end side and another end side, in the width direction, of the transfer path of the paper guide 33.

In other words, the projection portion 36 located at the left side in FIG. 5 has a posture inclined toward the outside (left side) from upstream (the lower side in FIG. 5, for example) toward downstream (the upper side in FIG. 5, for example) in the transport direction. On the other hand, the projection portion 36 located at the right side in FIG. 5 has a posture inclined toward the outside (right side) from upstream (the lower side in FIG. 5, for example) toward downstream (the upper side in FIG. 5, for example) in the transport direction.

A plurality (two pieces, for example) of the projection portions 36 are provided for each of the step-down surfaces 35. The plurality of projection portions 36 are provided on each of the step-down surfaces 35 so as to be adjacent to and parallel to each other.

As illustrated in FIG. 7, the projection portion 36 is formed such that the amount of protrusion from the step-down surface 35 is low at upstream (the lower side in FIG. 7, for example) in the transport direction and is high at downstream (the upper side in FIG. 7, for example).

As illustrated in FIG. 7, the maximum protruding portion of the projection portion 36 having such a configuration is set so as to be flush with the front surface of the middle portion, in the width direction, of the transfer path of the paper guide 33 as viewed from the side of the paper guide 33.

The paper guide 33 and the projection portion 36 are both formed of electrically conductive members. The projection portion 36 is formed of an electrically conductive member differing from that of the paper guide 33.

Specifically, the paper guide 33 is made, for example, of an iron-based metal (stainless steel or the like). The projection portion 36 is made, for example, of electrically conductive PPS (polyphenylene sulfide).

Next, an operation and manner when a sheet that has passed through the second transferring unit 25 is introduced into the fixing device 30 will be describe.

In the image forming device 1, a toner image is transferred to the sheet by the image transferring unit 20, and then, heat and pressure are applied by the fixing device 30 to fix it, whereby an image is formed on the sheet.

For example, in a case where full bleed (no margins) printing is performed on an A4R sheet in such an image forming device 1, this sheet passes through in a manner such that the sheet covers only the middle portion, in the width direction, of the transfer path of a band plate-shaped paper guide 33 provided at the introduction unit of the fixing device 30, and the step-down surface 35 at each of both ends, in the width direction, of the transfer path of the paper guide 33 is exposed. During a process in which the sheet on which a toner image has been transferred by the image transferring unit 20 is introduced into the introduction unit of the fixing device 30, there may occur a case in which the toner transferred at or around the sheet end portions flies off, and this toner is attached and accumulated at the step-down surfaces 35 of the transfer path of the paper guide 33.

In a case where normal printing is performed, for example, to an A3 sheet or an A4 sheet after the printing described above, although the sheet passes through in a manner such that the sheet covers the entire region in the width direction of the transfer path of the paper guide 33, the sheet is lead to the nip region between the fixing roller 31 and the pressure roller 32 while sliding on and coming into contact with the projection portion 36 of each of the step-down surfaces 35 at both ends in the width direction of the transfer path of the paper guide 33. This allows the sheet to avoid coming into contact with the step-down surfaces 35.

This makes it possible to prevent the toner that can be accumulated on the step-down surface 35 in association with the previous printing, from spreading onto the sheet, and hence, the sheet is not contaminated.

Thus, as compared with a case of replacing a paper guide 33 with a paper guide 33 that fits the size of the sheet serving as the target of printing for every printing mode, it is possible to eliminate the need of preparing a plurality of paper guides 33 having different sizes. This makes it possible to reduce the number of parts and reduce the facility cost, and also possible to eliminate the operation of replacing paper guides 33, as described in the related example.

In particular, in a case where the projection portion 36 includes a rib-shaped body and is disposed in a diagonal posture as in this first embodiment, it is possible to achieve an effect of correcting the curvature of the sheet that can happen at end portions during a process in which the sheet is guided to the nip region between the fixing roller 31 and the pressure roller 32 while sliding on and coming into contact with the projection portions 36 on the step-down surface 35 at each of both ends of the paper guide 33. This makes it possible to improve the straightness of the sheet.

In addition, in a case where the plurality of the projection portions 36 are provided on each of the step-down surfaces 35 so as to be adjacent to and parallel to each other as in this first embodiment, the sheet is less likely to come into contact with the step-down surfaces 35 during a process in which the sheet is guided to between the fixing roller 31 and the pressure roller 32 while sliding on and coming into contact with the projection portions 36 on each of the step-down surfaces 35 at the paper guide 33, as compared with a case where only one projection portion 36 is provided on each of the step-down surfaces 35.

In addition, in a case where the amount of protrusion of the projection portion 36 from the step-down surface 35 is set so as to be low at upstream in the transport direction and be high at downstream as in this first embodiment, the sheet that has been introduced into the introduction unit of the fixing device 30 can easily pass through toward the lower end side in the transport direction.

In addition, in a case where the projection portion 36 is made of electrically conductive PPS as in the first embodiment, there is no influence of static electricity occurring due to passing of a sheet or the like, and this makes it possible to enhance an effect of preventing an unfixed toner image that has been transferred on the sheet from becoming streaky due to the projection portion 36, as compared with a case where the projection portion 36 is formed of a member that does not have electrical conductivity.

As described above, with the fixing device 30 according to the first embodiment of the present disclosure, in a situation in which, for example, full bleed (no margins) printing is performed for A4R (printing in a manner such that a sheet passes through the paper guide 33 so as to cover only the middle portion, in the width direction, of the transfer path of the paper guide 33), and then, for example, normal printing is performed for A3 or A4 (printing in a manner such that a sheet passes through the paper guide 33 so as to cover the entire region, in the width direction, of the transfer path of the paper guide 33), it is possible to suppress or prevent spreading of toner to the sheet in the fixing process of the subsequent printing without using a plurality of paper guides 33 having different sizes in the width direction of the transfer path.

Note that the present disclosure is not limited to the first embodiment described above, and it is possible to make modification on an as-necessary basis within the scope of claims and the scope equivalent to the scope of claims.

### Second Embodiment

Although illustration is not given, it is possible to form the projection portions 36 according to the first embodiment integrally with the paper guide 33. This case also provides an operation and effect similar to those of the first embodiment described above.

### Third Embodiment

There is no particular limitation as to the number of projection portions 36 on each of the step-down surfaces 35 according to the first embodiment. Although illustration is not given, it is possible to provide one projection portion 36 or three or more projection portions 36 on each of the step-down surfaces 35, for example. This case also provides an operation and effect similar to those of the first embodiment described above.

### Fourth Embodiment

Although illustration is not given, it is possible to provide the projection portions 36 according to the first embodiment at the middle portion, in the width direction, of the transfer path of the paper guide 33.

In this configuration, it is preferable that the maximum protruding portion of the projection portion 36 on each of the step-down surface 35 be set so as to be flush with the maximum protruding portion of the projection portion at the middle portion as viewed from the side of the paper guide 33. In order to achieve such setting, it is possible to employ an idea in which the height of protrusion of the entire length of the projection portion 36 from the step-down surface 35 is greater than the height of protrusion of the entire region of the projection portion from the middle portion. This case also provides an operation and effect similar to those of the first embodiment described above.

### Fifth Embodiment

Although illustration is not given, it is possible to employ a configuration in which no projection portion 36 according to the first embodiment described above is provided.

In this configuration, in a case where, for example, full bleed (no margins) printing is performed for A4R (printing in a manner such that a sheet passes through the paper guide 33 so as to cover only the middle portion, in the width direction, of the transfer path of the paper guide 33), and then, for example, normal printing is performed for A3 or A4 (printing in a manner such that a sheet passes through the paper guide 33 so as to cover the entire region, in the width direction, of the transfer path of the paper guide 33), toner may be accumulated on the step-down surfaces 35 at both ends, in the width direction, of the transfer path of the paper guide 33 in association with the former printing described above. Even if this accumulation happens, although the normal printing described above is performed such that the sheet passes through the paper guide 33 so as to cover the entire region, in the width direction, of the transfer path of the paper guide 33, the sheet is guided to between the fixing roller 31 and the pressure roller 32 while sliding on and coming into contact with the middle portion, in the width direction, of the transfer path of the paper guide 33. Thus, the sheet does not come into contact with the step-down surface 35 at both ends, in the width direction, of the transfer path of the paper guide 33. This makes it possible to prevent spreading, to the sheet, of toner that can be accumulated on the step-down surface 35 in association with the former printing described above, which makes it possible to avoid contamination of the sheet.

### Sixth Embodiment

Although illustration is not given, it is possible to form the projection portions 36 according to the first embodiment described above using PFA (perfluoroalkoxyalkane polymer) or the like that does not have electrical conductivity, for example.

As compared with a case where the projection portions 36 is made of PPS as in the first embodiment, this configuration makes it possible to suppress spreading of the toner to the sheet during a fixing process in the subsequent printing described above, although it reduces the effect of preventing an unfixed toner image that has been transferred on the sheet from being damaged in a form of streaks due to the projection portion 36.

It is possible to favorably use the present disclosure in the fixing device and the image forming device.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A fixing device comprising:
an introduction unit through which a recording medium having a front surface on which a toner image is transferred is introduced; and
a fixing member that applies heat and pressure to the introduced recording medium to fix the toner image on the recording medium, wherein
a paper guide that guides the recording medium to the fixing member is disposed at the introduction unit,
the paper guide is disposed over a width direction of a transfer path through which the recording medium is guided to the introduction unit, and
one end portion and another end portion, in the width direction, of the transfer path of the paper guide have a step-down surface that retracts so as not to come into contact with the recording medium.

2. The fixing device according to claim 1, wherein
one or more projection portions are provided at the step-down surface, the projection portions coming into contact with the recording medium to cause the recording medium to be spaced apart from the step-down surface.

3. The fixing device according to claim 2, wherein
the projection portion has a rib-shaped body extending at the paper guide from upstream to downstream in a transport direction of the recording medium, and
the projection portion has a diagonal posture to change a contact position with the recording medium from a middle position in the transport direction toward one end side and another end side, in the width direction, of the transfer path of the paper guide.

4. The fixing device according to claim 3, wherein
a plurality of the projection portions are provided on each of the step-down surfaces so as to be adjacent to and parallel to each other.

5. The fixing device according to claim 2, wherein
the projection portion is formed such that an amount of protrusion from the step-down surface decreases upstream and increases downstream in the transport direction.

6. The fixing device according to claim 2, wherein
the paper guide is formed of an electrically conductive member, and
the projection portion is formed separately from the paper guide and is formed of an electrically conductive member differing from the paper guide.

7. An image forming device comprising the fixing device according to claim 1.

8. An image forming device comprising the fixing device according to claim 6.
